(19) United States
(12) Patent Application Publication
(10) Pub. No.: US 2006/0080328 A1
(43) Pub. Date: Apr. 13, 2006

(54) Information fusion

(76) Inventor: James A. Anderson, Barrington, RI (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/961,741

(22) Filed: Oct. 8, 2004

(51) Int. Cl. H04L 12/16; H04Q 11/00

(52) U.S. Cl. 707/100

(57) ABSTRACT

Methods and systems of integrating information include spatial representation of parameter values. In some embodiments, parameter values are positioned along edges of an array and geometrical constructs based on the parameter positions are used to integrate the parameter values. In some embodiments, arrays of modules that correspond in their properties to attractor networks are used in combination with activity patterns that represent parameter values to integrate information. The methods and systems may be used to categorize objects into classes or concepts. For example, frequency agile radar emitters may be detected and/or classified using techniques described herein.

### BACKGROUND

Information fusion, sometimes referred to as “information integration” or “sensor fusion,” includes methods of integrating, filtering and/or correlating information from various information sources into a unified interpretation that is appropriate for making decisions. Examples of information sources include sensors, databases, humans and other information gathering and storage systems.

Multi-sensor systems can provide many benefits, but also can require large amounts of data processing or result in an overload of information. Information fusion can provide, in many instances, useful and often improved information. For example, the fusion of redundant information from multiple sources can increase the accuracy of a system. The fusion of complementary information from multiple sources can result in improved information because the use of multiple sources may increase spatial or temporal coverage.

Information fusion has been used in numerous military applications, including surveillance systems, intelligence collection systems, indications and warning systems, and autonomous weaponry systems. Current commercial applications of information fusion include robotics, remote sensing, image processing and medical systems.

### SUMMARY

The present invention is directed to new methods and systems for integrating information from multiple information sources to form a unified representation. Embodiments of the invention include spatial representation of information provided by information sources, e.g., data from sensors. In some embodiments, geometrical constructs may be formed to elicit spatial properties of the provided information. These geometrical constructs may be used as an aid to pattern recognition and/or the extraction of commonalities in an input set.

Methods disclosed herein may be put into operation using a topographic computing structure. In some embodiments, information integration methods may be implemented on a system constructed with an array of locally collected modules, for example, a network of networks. Arrays of processors, such as those found massively parallel computing systems, may be used for implementing many of the embodiments disclosed herein. It is important to note that various aspects of the embodiments described below may be combined.

According to one embodiment of the invention, a system for integrating multiple pieces of information comprises an at least two-dimensional array of locally-connected modules, the modules being configured to have a plurality of attractor states. The system further comprises a plurality of information elements, positioned relative to the array, that provide information to the array in the form of activity patterns which travel within the array via local connections between the modules. For a positioning of the information elements, each module of a first subset of the modules first receives an activity pattern from a first information element coincidentally with first receiving an activity pattern from a second information element. Each module of the first subset of modules has an attractor state that corresponds to a coincidence of the activity patterns from the first and second information elements.

In some embodiments, at least one module of the first subset of modules first receives an activity pattern from a third information element coincidentally with first receiving an activity pattern from a fourth information element, and the system identifies the at least one module. In some embodiments, at least one module of the first subset of modules first receives an activity pattern from a third information element coincidentally with first receiving an activity pattern from a fourth information element, and also receives an activity pattern from a fifth information element coincidentally with first receiving an activity pattern from a sixth information element. In some embodiments, the first subset of modules is within an interference pattern and a plurality of interference patterns are present within the array of modules. In some embodiments, a module of the first subset of modules has an attractor state that corresponds to being within one, two, or three of the interference patterns. In some embodiments, the system further comprises a hierarchy component that generates a hierarchy of modules based on results of multiple instances of positionings of the plurality of information elements relative to the array. The results may comprise a tracking of which modules of the first subset of modules first receives an activity pattern from a third information element coincidentally when first receiving an activity pattern from a fourth information element for at least two instances of positionings of the plurality of information elements. In some embodiments, the information elements are positioned on edges of the array. In some embodiments, the information elements are positioned within the array. In some embodiments, the array is part of a group attractor networks. In some embodiments, the system is adapted to receive electromagnetic pulse parameter values of a plurality of electromagnetic pulses, wherein the electromagnetic pulse parameter values are assigned to the information elements and the information elements are placed relative to the array based on the values of the electromagnetic pulse parameters. The system, in some embodiments, classifies the electromagnetic pulses based on the hierarchy of modules. In some embodiments, the electromagnetic pulse parameters comprise frequency and at least two other electromagnetic pulse parameters. In some embodiments of the system, the results aid in investigating the presence of emitters of the electromagnetic pulses that are emitted from frequency agility emitters. In some embodiments, the hierarchy of modules includes a hierarchy based on the number of times each module of the first subset of modules received an activity pattern from a third information element coincidentally with first receiving an activity pattern from a fourth information element during all of the multiple instances of placements of the plurality of information elements relative to the array. In some embodiments, the activity patterns are vector patterns and the modules correspond in their properties to attractor nureal networks. In some embodiments the modules comprise CPUs. In some embodiments, first receiving an activity pattern from a first information element coincidentally with first receiving an activity pattern from a second information element comprises first receiving an activity pattern from a first information element approximately simultaneously with first receiving an activity pattern from a second information element.

In another embodiment of the invention, a method of integrating data comprises a method of integrating data, the method comprising: (a) spatially representing, relative to an array of array elements, values for at least three parameters by placing each parameter value on a separate span of values; and (b) identifying an array element that is approximately equidistant from each spatially-represented parameter value of a first pair of spatially-represented parameter values and equidistant from each spatially represented parameter value of a second pair of spatially-represented parameter values.

In some embodiments, the second pair has no spatially-represented parameter values in common with the first pair, while in other embodiments the second pair has one spatially-represented parameter value in common with the first pair. In some embodiments, the method comprises identifying an interference pattern for each pair of parameter values, and identifying array elements that include two or more interference patterns. In some embodiments, the method further comprises identifying an array element that is additionally approximately equidistant from each spatially-represented parameter value of a third pair of spatially-represented parameter values. In some embodiments, the method further comprises determining the number of parameter values from which the array element is approximately equidistant for each array element that is approximately equidistant from two parameter values. In some embodiments, the method further comprises classifying array elements based at least in part on the number of parameter values from which the array elements are approximately equidistant. In some embodiments, the method further comprises repeating (a) and (b) using new values for the three parameters, and generating a hierarchy of array elements based at least in part on the number of times that an array element is identified during the performances of (b). In some embodiments, the at least three parameters comprise electromagnetic pulse parameters. In some embodiments, the at least three parameters comprise electromagnetic pulse parameters. In some embodiments, the electromagnetic pulse parameters comprise frequency and at least two other electromagnetic pulse parameters. In some embodiments, the electromagnetic pulse parameters comprise frequency, intensity, pulse width, angle of arrival, and time of arrival. In some embodiments, the three parameters comprise flow cytometry parameters.

In another embodiment of the invention, a computer-readable medium has computer-readable signals stored thereon that define instructions that, as a result of being executed by a computer, instruct the computer to perform a method of identifying higher-stability coincidences representing relationships between information elements, the method comprising acts of: (a) positioning a plurality of information elements on a plurality of associated spans of values, the spans being situated relative to an array of array elements, the position of each information element on its associated span being based on a first value contained by the information element; (b) identifying array elements that include at least two geometrical constructs related to the position of the information elements having first values; (c) repositioning each of the plurality of information elements on its associated span of values, the position of each information element on its associated span being based on a second value contained by the information element, wherein the second value of at least one of the information elements is different from the first value of the information element; (d) identifying array elements through that include at least two geometrical constructs related to the position of the information elements having second values; and (e) differentiating between array elements identified in both (b) and (d) as compared to array elements identified in only one of (b) and (d).

In some embodiments, the method further comprises repeating (c) and (d) for a plurality of values, and creating a hierarchy of array elements based on the number of times positioning or repositioning the information elements results in an array element including at least two geometrical constructs related to the position of the information elements. In some embodiments, the geometrical constructs are perpendicular bisectors of linear connections between each pair of information elements. In some embodiments of the method, the plurality of spans of values comprises a plurality of axes. In some embodiments of the method, the axes comprise linear axes situated relative to an array of grid spaces. In some embodiments of the method, the array of array elements is a two-dimensional array, and the plurality of axes comprises at least four axes. In some embodiments of the method, each of the at least four axes is situated perpendicularly to two of the axes. In some embodiments of the method, the geometrical constructs are perpendicular bi-sectors of linear connections between each pair of information elements. In some embodiments of the method, at least one of the information elements has a numerical value. In some embodiments of the method, at least one of the information elements has a qualitative value. In some embodiments of the method the plurality of spans of values comprises a plurality of surfaces. In some embodiments the array of array elements is three-dimensional, and in some embodiments the array of array elements is at least four-dimensional.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1A shows a two-dimensional grid with parameters positioned at edges of the grid and linear connections formed between the parameter positions, according to one embodiment of the invention;

FIG. 1B shows perpendicular bisectors of the linear connections shown in FIG. 1A, and also shows shaded grid spaces that include coincidences of the perpendicular bisectors, according to one embodiment of the invention;

FIG. 2 shows a core grid space according to one embodiment of the invention;

FIG. 3 shows one example of perpendicular bisector behavior in the presence of parameter noise;

FIG. 4 is a block diagram of one embodiment of an information integration system according to one aspect of the invention;

FIG. 5 is a flowchart of one embodiment of a method of creating hierarchies;

FIG. 6 is a flow chart of one embodiment of a sub-method of an act shown in FIG. 5;

FIG. 7A shows one embodiment of an array of modules;

FIG. 7B shows information elements, from which activity patterns may emanate, positioned relative to the array of modules;

FIG. 8A shows a general-purpose computer system that may be used to implement various aspects of the invention; and

FIG. 8B shows one embodiment of the storage system shown in FIG. 8.

### DETAILED DESCRIPTION

The present invention is directed to new methods and systems for integrating information, sometimes referred to as “information fusion” or “sensor fusion”. In some embodiments, a method involves spatially representing information relative to an array. Geometrical constructs based on the spatial representation of the information may then be used to form unified representations of the information. Such a method is useful for many applications, for example, analysis of radar pulses for radar categorization, biological instrumentation such as flow cytometry feature recognition, concept recognition, and various other applications.

In some cases, the methods and systems described herein are particularly amenable to use with systems that include arrays of locally connected modules. For example, methods described herein may be implemented on a network of networks (hereinafter referred to as “NoN”) as described in U.S. patent application Ser. No. 5,842,190 issued Nov. 28, 1998 to Sutton et al., which is hereby incorporated herein by reference in its entirety. The topographical nature of NoN systems lends itself to the information integration methods described herein.

In many cases, a user of raw data prefers qualitative information as compared to the quantitative data provided by many sensors. To provide qualitative information, in certain applications, novel methods of information fusion may be used. The methods and systems described herein may be used to form hierarchical linked structures somewhat like those typical of human concepts. In some embodiments, hierarchies that span from broad concepts down through to specific examples may be formed to provide for a better understanding of data.

The functions and advantages of embodiments of the present invention will be more fully understood from the examples described below. The following examples are intended to illustrate the benefits of the present invention, but do not necessarily exemplify the full scope of the invention.

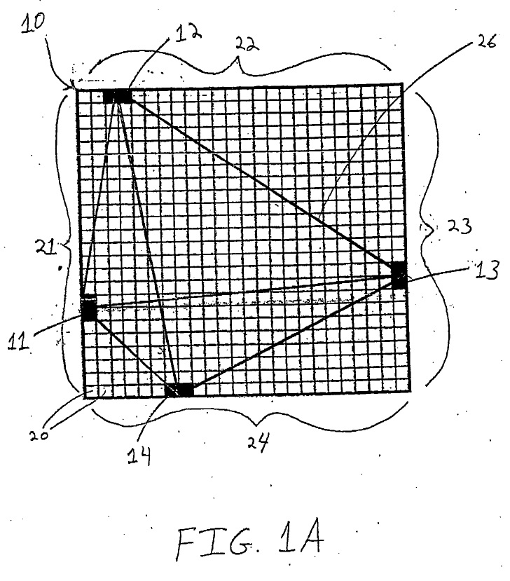

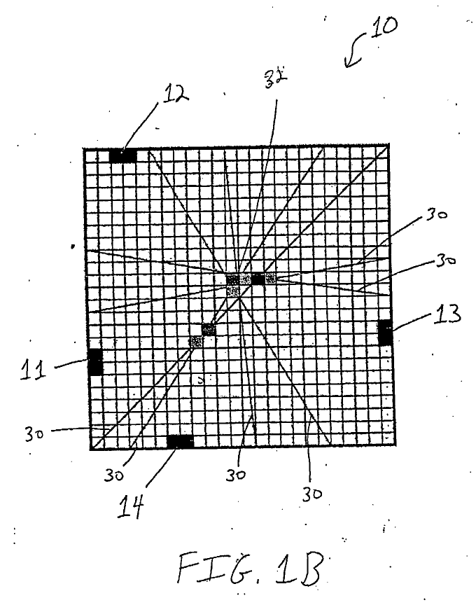

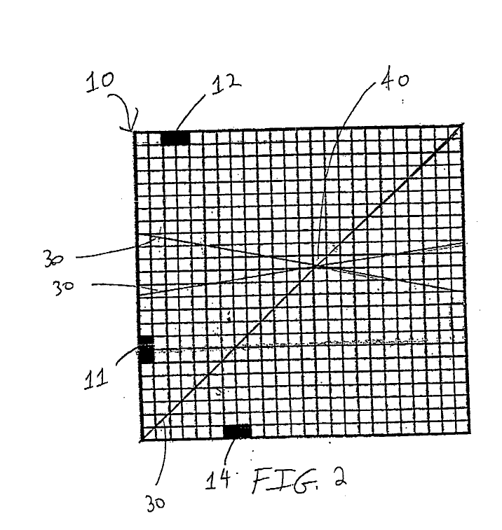

One specific visual representation of some of the methods and systems described herein is shown in FIGS. 1A, 1B and 2. Those of ordinary skill in the art will recognize that a variety of visual representations are possible, and various aspects of this example are not considered to be limiting.

FIG. 1A shows a grid 10 formed of an array of grid spaces 20. Information elements, which in this embodiment include a first parameter 11, a second parameter 12, a third parameter 13, and a fourth parameter 14, are positioned along edges of grid 10. The parameters are placed along each edge according to the value of the parameter. For example, first parameter 11 is positioned within a first span of values 21 (in this embodiment, an edge) according to the value of first parameter 11. First parameter 11 may have a value that falls in a range represented by the seventh and eighth grid spaces from the bottom of first span 21. Second parameter 12 may have a value that is contained within a range represented by the third and fourth grid spaces from the left side of a second span of values 22. Similarly, each of third parameter 13 and fourth parameter 14 may be positioned within a third span of values 23 and a fourth span of values 24, respectively. Such a topographic coding scheme is sometimes referred to as the use of “bar codes” in neural network literature because the scheme represents the numerical value of a parameter as a location of a region of activation on a geometric object such as a line, a surface or other region.

Although one parameter is shown on each edge of grid 10, multiple parameters or multiple values for each parameter may be placed on any or all of the edges in some embodiments. Although spans 21, 22, 23, 24 are shown to be arranged on the edges of grid 10, spans may be arranged at any suitable location relative to the grid, including within the grid and spaced apart from the grid. Grid 10 does not necessarily have to have a square shape as it may be a rectangle, a circle, a pentagon, a triangle, an oval, or any other suitable shape. A parameter does not need to be placed on every edge or on every span for information integration to occur. In some cases, a single numerical parameter value may occupy more than one location on a span of values, for example, a single numerical parameter value may occupy multiple adjacent modules. A two-dimensional grid is used as an array in the embodiment of FIG. 1A, but in some embodiments, an array of higher dimension may be used. For example, a three-dimensional array may be used which includes surfaces as spans of values for positioning information elements. Or, in some cases, linear or non-linear axes may be used as spans of values in a three-dimensional array.

Grid 10 is shown as having equally-sized grid spaces 20 throughout grid 10. In some embodiments, arrays, such as grids, may include array elements, such as grid spaces, that differ in size and/or shape at different locations throughout the array. Similarly, the spans of values may have different resolutions or sizes from one another. For example, first parameter 11 may have 48 position location options, while second parameter 12 may have 24 position location options. In some embodiments, the resolution of a span of values may change within that same span of values.

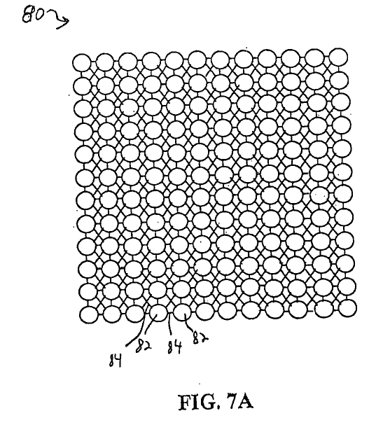

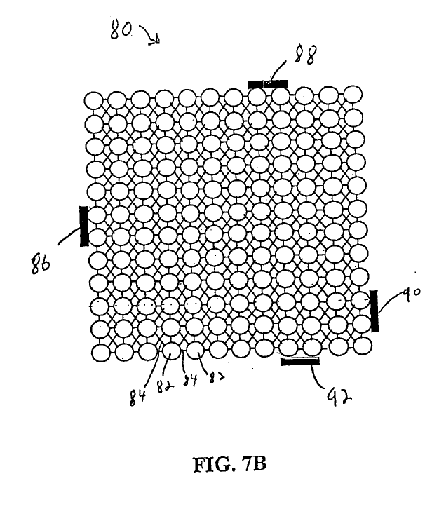

Linear connections 26 are shown connecting the positions of parameters 11, 12, 13, 14 as examples of geometrical constructs which may be formed based on the positions of the parameters. Perpendicular bisectors 30 are shown in FIG. 1B for each of the six linear connections 26 shown in FIG. 1A. Perpendicular bisectors 30 are another example of geometrical constructs that may be formed based on the positions of parameters 11, 12, 13, 14. As described below with reference to FIGS. 7A and 7B, perpendicular bisectors 30 may represent interference patterns of propagating pattern waves in certain embodiments of the invention.

Coincidences, as used herein, are approximate intersections or exact intersections of geometrical constructs, activity patterns, or interference patterns. Array elements, such as grid spaces, which include intersections or include two or more geometrical constructs or interference patterns may also considered to be coincidences. For example, in FIG. 1B, perpendicular bisectors 30 intersect one another at various locations throughout grid 10. Grid spaces 20 which contain a coincidence are shown as shaded grid spaces 32. Different shadings may represent different number of coincidences within a grid space or the number of perpendicular bisectors 30 intersecting at a single coincidence. Many of the coincidences include two perpendicular bisectors 30 intersecting one another. However, there may be “higher-order” coincidences which include the intersection of three or more perpendicular bisectors 30 and also include array elements that are approximately equidistant from three or more information elements. For example, FIG. 2 shows three perpendicular bisectors 30 intersecting in a grid space 40. A perpendicular bisector line represents a set of points in which each point is equidistant from the pair of information elements from which the linear connections are formed. An intersection of two perpendicular bisectors may represent a point that is equidistant from two pairs of information elements. In some cases, the two pairs of information elements share one common information elements, such that the intersection is equidistant from three information elements, and in other cases, the two pairs of information elements have no information element in common.

Coincidences are not necessarily identified with extreme precision. For example, in some cases, it is adequate to identify the grid space or array element in which a coincidence is located. In other cases, it is adequate to identify the probability of a coincidence being located at a certain location or within a certain array element. A coincidence does not necessarily only merge data. The location of a coincidence may represent both the values of information elements and the spatial relationship between the information value sources. Changing the spatial relationship between information value sources may alter the location of coincidences without changing the values themselves.

As the coincidences may be concentrated toward the middle of grid 10, a finer resolution may be used for the center region of grid 10. In some embodiments, various levels of resolutions can be used at different locations throughout grid 10.

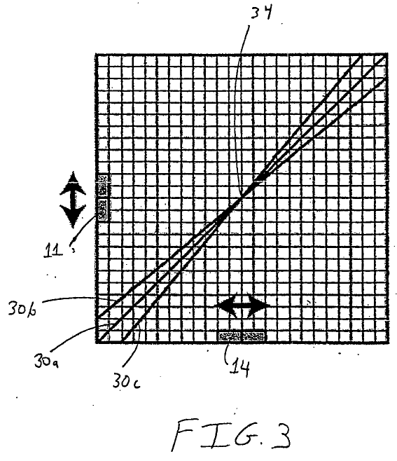

The effect of noise within the parameter values on resultant coincidences is shown in FIG. 3. In this example, the positions of first parameter 11 and fourth parameter 14 each vary between two positions. The resulting perpendicular bisectors 30a, 30b, 30b are shown. Although the perpendicular bisector varies when noise is added to first parameter 11 and fourth parameter 14, the average perpendicular bisector remains the same as the perpendicular bisector associated with the original parameter locations, and the perpendicular bisector passes through a same center point 34 for each set of parameter positions. This behavior is one example of how quantitative precision is not necessarily required to provide value using the methods and systems described herein.

Some applications of methods disclosed herein may be used to yield qualitative understanding of complex systems, rather than quantitative understanding. Qualitative understanding often includes recognizing that different sets of parameter values may describe the same situation or may be members of the same class. Excessive quantitative precision may, in some situations, actually interfere with such desirable qualitative understanding.

As one application of such qualitative understanding, embodiments of the invention may allow for formation of hierarchical concept representations. Of course, hierarchical concept representations may also be used in quantitative understanding contexts. In one example, where separate instances (i.e., multiple sets of values, each set having a value for each parameter) of parameters 11, 12, 13, 14 define separate examples of a type of object, and three of the parameter values (for example, first parameter 11 second parameter 12 and fourth parameter 14) remain fixed for separate objects, and one or more other parameters (for example, third parameter 13) varies widely from separate object to separate object, two different types of spatial data may be developed. The first type of spatial data may represent a stable core, for example a set of grid spaces that contain coincidences for each separate object. For example, as shown in FIG. 2, grid space 40 contains a coincidence that represents the intersection of three perpendicular bisectors 30 regardless of the position of third parameter 13 because first parameter 11, second parameter 12 and fourth parameter 14 remain fixed. Such higher-stability coincidences may be useful in extracting an object class or a concept from data that includes multiple object classes or concepts.

The second type of spatial data includes specific examples of objects resulting from the additional coincidences formed based on the position of the third parameter 13. Thus, analysis of multiple arrays having array elements that include coincidences may reveal classes of objects that have a common core. The additional array elements that show coincidences that are not common to an entire class of objects may provide information related to specific examples of objects.

When multiple examples of objects are spatially represented and array elements are tracked for how often a coincidence occurs within each array element, a hierarchy may be generated based on how often an array element contains a coincidence. Such a hierarchy may be useful when using or analyzing human concepts, because human concepts in some cases have a hierarchical structure.

Methods and systems described herein may apply hierarchical concept representations to the field of radar to detect and characterize frequency agile emitters. Frequency agility is a common technique used with military radar to avoid detection. Frequency agile emitters change the radar pulse frequency with every pulse, and because frequency the most reliable pulse parameter for detection purposes, such emitters can be difficult to detect. In FIG. 1B, third information element 13 may correspond to frequency, and for each instance of a set of parameter values, the location of information element 13 would likely change. The other pulse parameters (pulse width, angle of arrival, pulse shape), however, remain fixed for technical reasons. Therefore, the information element locations for the other three parameters will be constant for each instance of a set of parameter values.

Each of the pulses from one emitter may correspond to a concept, and this concept may be spatially represented by a stable core of coincidences that appear for each instance of a set of parameter values. Individual pulses, or examples of the concept, would be represented by further coincidences additional to the stable core of coincidences.

Another application of the methods and system described herein would be for detection of radar emitter classes. Radar emitters of the same type typically have many similar properties such as frequency band of operation, pulse width, pulse repetition rate statistics, pulse shape, and others. Due to manufacturing differences and specific parameters chosen for operation, each emitter may have its own idiosyncrasies. By using the methods and systems described herein, the presence of invariant class resemblances may be detected.

It is important to note that a concept is not necessarily a precise definition of a class of objects or even a quantitative description of objects. Concepts may be groupings based on similarities of various parameters or descriptors.

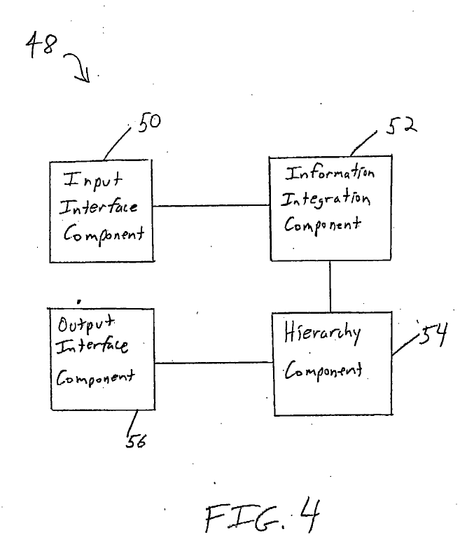

FIG. 4 shows a block diagram of one embodiment of a system 48 configured to implement methods described herein. An input interface component 50 allows for the provision of input information to an information integration component 52. Input interface component 50 may be an application or part of an application that enables a user or another system (e.g., a system containing sensors or databases) to interface with information integration component 52 during use of system 48. Input interface component 50 may be attached to a communications network, a transmission medium, or any other suitable device, component or application which allows for the receipt of input information.

Information integration component 52 works with the input information according to one or more of the methods described herein or equivalents thereof. For example, information integration component 52 may create linear connections and perpendicular bisectors to determine the presence of coincidences within an array. In another embodiment, information integration component 52 may position information elements around a NoN and propagate activity patterns as representations of the information elements according to methods described herein with reference to FIGS. 7A and 7B.

In some embodiments, a hierarchy component 54 may receive results from information integration component 52, e.g., a listing of coincidences for each example of multiple examples of objects or sets of parameters, and form hierarchies based on these results.

An output interface component 56, in some embodiments, receives results from hierarchy component 54 and/or information integration component 52, and allows for the output of these results to a user, an application, or another system. Output interface component 56 may be configured to provide output in response to requests from a user, an application, or another system. The particular type of output interface component 56 is not critical and not intended to be limiting.

System 48, and components thereof, such as information integration component 52 and hierarchy component 54, may be implemented using software (e.g., C, C#, C++, Java, or a combination thereof), hardware (e.g., one or more application-specific integrated circuits), firmware (e.g., electrically-programmed memory) or any combination thereof. One or more of the components of system 48 may reside on a single system, or one or more components may reside on separate, discrete systems. Further, each component may be distributed across multiple systems, such a plurality of locally connected CPUs, and one or more of the systems may be interconnected.

Further, on each of the one or more systems that include one or more components of system 48, each of the components may reside in one or more locations on the system. For example, different portions of information integration component 52 and hierarchy component 54 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

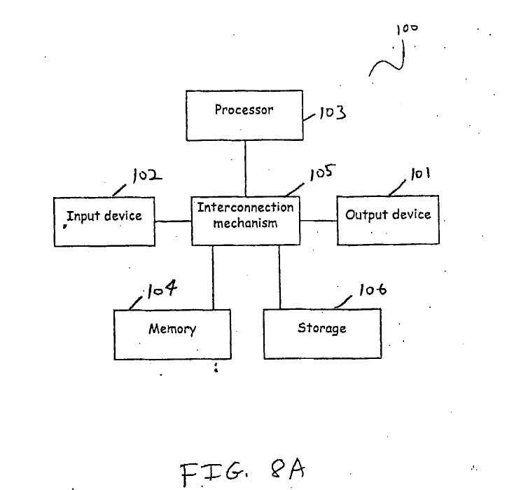

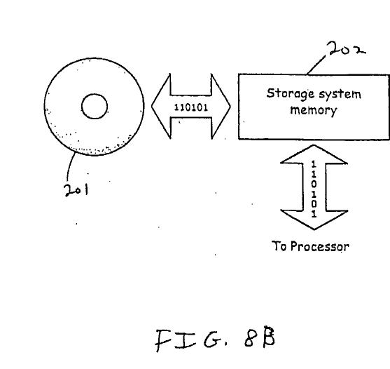

System 48 may be implemented on a computer system described below in relation to FIGS. 8A and 8B.

System 48 is merely an illustrative embodiment of integrating information. Such an illustrative embodiment is not intended to limit the scope of the invention, as any of numerous other implementations of information integration, for example, variations of system 48, are possible and are intended to fall within the scope of the invention.

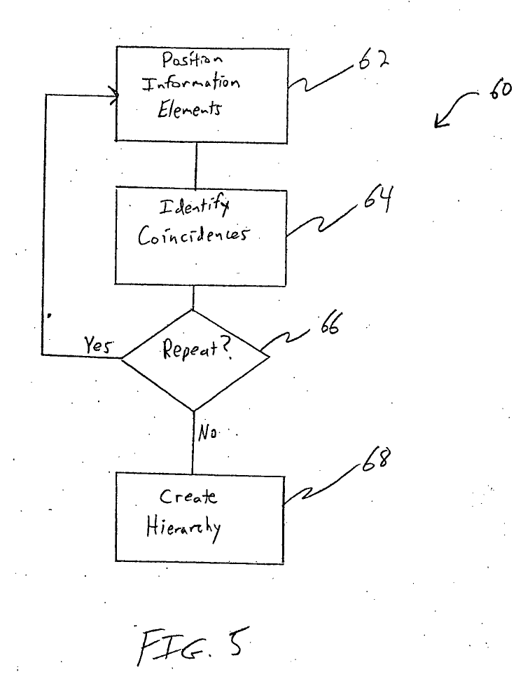

FIG. 5 is a flow chart of one embodiment of a method 60 of creating hierarchies. Although method 60 is described below with reference to spatial and geometrical terms, method 60 does not have to explicitly perform the various acts on a physically existing array or in a manner that directly corresponds to a physical representation of the acts. For example, when using a two-dimensional array and positioning parameters along the edges of the array, the array and the parameter positions may be represented mathematically or computationally within a CPU or memory storage device in a manner that merely represents the array in such a way that data can be input, processed, and output in a manner consistent with the existence of an array.

In an act 62, information elements are positioned relative to an array. As discussed above with reference to FIG. 1A, the positioning of information elements need not occur along the edges of an array but may occur within the array or outside of the array. The information elements may be parameter values, such as quantitative values, or qualitative values, such as choices from a set of discrete options. For example, a span of a plurality of words may extend along an edge of the array, and the presence of a specific word as an information element may result in the positioning of the information element at a specific location on the span of words. Another example of input data that includes choices from a set of discrete options includes a choice of a model-type from a plurality of model types for a commercial application. Examples of other methods of positioning information elements include positioning of elements or activation of regions that represent aspects of input data that are not necessarily numerical or quantitative. For example, the presence or absence of specific features of input data might trigger certain positioning or activation. For example, input data including “living” versus “non-living” or “green” versus “blue” might be used to activate certain regions.

A span of values may also include relative values as opposed to absolute values. The precision of such coding may be low. For example, a span may include regions for positioning an information element that include “low value”, “medium value”, and “high value”. In some cases, these regions may be dynamically adjusted based on the absolute values that are observed for multiple sets of information elements.

Not all of the information elements need to be positioned before proceeding to another act in method 60. For example, after several information elements have been positioned relative to an array, geometrical constructs and/or interference patterns may be formed in an act 64. Additional geometrical constructs and/or interference patterns then may be formed once further information elements are positioned relative to the array.

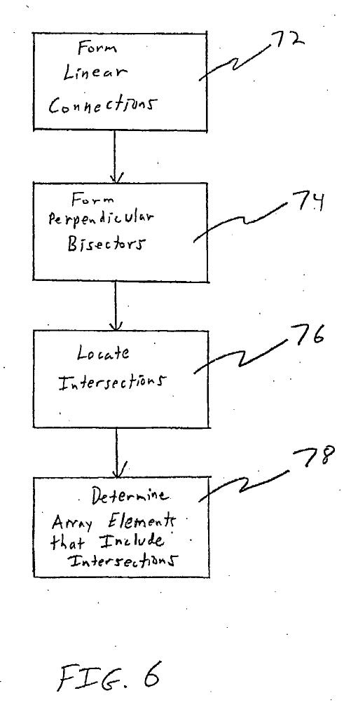

In act 64, aspects of coincidences of geometrical constructs and/or interference patterns are identified. For example, act 64 may include identifying which array elements contain the coincidences, or act 64 may include precisely identifying the location of coincidences. The number of intersecting entities that form each coincidence may also be identified in act 64. Coincidences may be identified by any suitable method. For example, if a NoN is being used in conjunction with activity patterns, coincidences may be identified by locating modules that have attained a specific attractor state (discussed with reference to FIGS. 7A and 7B). If geometrical constructs are being used, as described by way of example in FIGS. 1A and 1B, mathematical computations may be used to determine the locations or approximate locations of coincidences. Act 64 may include explicit steps of defining linear connections between parameter values and then determining perpendicular bisectors of those linear connections and their resulting intersections. Such an embodiment of act 64 is described herein with reference to FIG. 6.

In an act 66, a decision is made whether to repeat acts 62 and 64. If another set of information elements is to be addressed, acts 62 and 64 may be repeated. If no further sets of information elements remain, a further act such as an act 68 may be performed. Those of skill in the art will recognize that act 68 may be started before all repetitions of act 62 and 64 are completed. For example, a hierarchy may be created after two repetitions of acts 62 and 64, and the hierarchy may be revised and/or updated as further repetitions are performed.

In some embodiments, an act 68 includes forming hierarchical structures by investigating the frequency of coincidences appearing in certain array elements. Further analysis or processing may occur to form concepts, associatively linked structures, or semantic networks.

Method 60 may include additional acts. Further, the order of the acts performed as part of method 60 is not limited to the order illustrated in FIG. 5 as the acts may be performed in other orders, and one or more of the acts of method 60 may be performed in series or in parallel to one or more other acts, or parts thereof.

FIG. 6 is a block diagram of one example of a particular method 70 for performing act 64 shown in FIG. 5. In an act 72, linear connections are formed between information elements. The linear connections do not need to be perfectly linear, for example, the linear connections may include a series of short lines or curves that connect to form a path between two information elements that is substantially linear. One example of a substantially linear path includes a “city block” method of traveling from one point to another point on a grid. In some cases, the linear connection may be represented by a line that has different properties at different points along the line.

In an act 74, perpendicular bisectors are formed for at least some of the linear connections formed in act 72. Act 74 may include a strictly mathematical formation of a perpendicular bisector, or a perpendicular bisector formed as an average of several fairly similar linear connections, or may include a weighted perpendicular bisector that takes into account properties of the linear connection.

In an act 76, intersections of the perpendicular bisectors are located. Act 76 may include a visual investigation of a visual display of the perpendicular bisectors. In some embodiments, array elements themselves are able to detect intersections and provide information to a system, a user, or an application.

In an act 78, array elements are identified in which the intersections of the perpendicular bisectors are located. Act 78 may be performed by a processor, or may be performed by visually analyzing an array (whether it be by a human or an automatic scanning technology). In some embodiments, the array elements themselves are able to signal the presence of perpendicular bisector intersections.

Method 70 is merely an illustrative embodiment of identifying coincidences. Such an illustrative embodiment is not intended to limit the scope of the invention, as any of numerous other implementations of identifying coincidences, for example, variations of act 70, are possible and are intended to fall within the scope of the invention.

FIG. 7A shows one embodiment of an array 80 of modules 82. Array 80 may form a NoN. In a NoN, the basic computing unit may be an attractor network. Thus, if array 80 represents a NoN, each module 82 may include an attractor network. Attractor networks are non-linear dynamical systems that evolve over time into a stable state. The stable states may be a single point or a limit cycle. The activity of attractor networks is dominated by their attractor states. A single attractor network may simultaneously have multiple stable attractor states, and the activity of an attractor network may be approximated as a weighted sum of its attractor states. For the remainder of the description of FIGS. 7A and 7B, a module is assumed to be an attractor network, but other suitable modules may be used.

Modules 82 are locally connected to neighbor modules. Interactions between modules may be approximated by interactions between their attractor states, and may be described by state interaction matrices. The state interaction matrix elements give the contribution of an attractor state in one module to the amplitude of an attractor state in a module connected to the one module.

As vector patterns are transmitted across the modules via local transmission between modules, traveling pattern waves may be formed. When two different traveling pattern waves collide, interference patterns representing the coincidence of traveling pattern waves may be formed. When two or more different pattern waves meet at a module, and form an interference pattern, a new attractor state may be generated at the module. Intersections of interference patterns may lead to further new attractor states, and these new attractor states may be used as a way of tracking or recording coincidences of information. Coincidences may represent intersections of interference patterns, but unless explicitly stated, the interference patterns do not have to first arrive at a module simultaneously. In some cases, the intersections of these interference patterns may roughly correspond to the intersections of the perpendicular bisectors of linear connections of the entry points of the activity patterns.

In some embodiments of NoNs, a system architecture may include an array of a large number of simple CPUs connected locally to each other and arranged in a two-dimensional array. Longer range connections between CPUs may be simulated in software.

FIG. 7B shows a two-dimensional array 80 of locally-connected modules 82 with information elements 86, 88, 90, 92 positioned relative to the array in a geometrical configuration in a manner similar to the embodiment shown in FIG. 1A. The information elements provide information to the array in the form of activity patterns which travel within the array via local connections 84 between the modules. When a module first receives an activity pattern from a first information element 86 coincidentally with first receiving an activity pattern from a second information element 88, this module may achieve a new attractor state or a predefined attractor state, either of which may correspond to a coincidence of the activity patterns from the first and second information elements 86, 88. This event may occur for a subset of modules of the array of modules and form an interference pattern, for example, a line that is roughly a perpendicular bisector of a linear connection of two information elements.

Intersections of these interference patterns form coincidences as discussed above with reference to FIGS. 1B and 2. Modules which include coincidences of interference patterns may signal the presence of an interference pattern or otherwise indicate their attractor state such that the topographic locations of the coincidences may be mapped.

Definitions

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Original Eighth Edition, August 2001), Section 2111.03.

As used herein, a “network” or a “communications network” is group of two or more devices or applications interconnected by one or more segments of transmission media on which communications may be exchanged between the devices. Each segment may be any of a plurality of types of transmission media, including one or more electrical or optical wires or cables made of metal and/or optical fiber, air (e.g., using wireless transmission over carrier waves) or any combination of these transmission media.

Method 60, method 70, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof. The computer-readable medium on which such instructions are stored may reside on one or more of the components of system 48 described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described below in relation to FIGS. 8A and 8B, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to perform information integration according to various embodiments of the invention. Further, the software design system may be located on a single computer or may be distributed among a plurality of computers attached by a communications network.

Various embodiments according to the invention may be implemented on massively parallel hardware, for example, the Connection Machine designed and manufactured by Thinking Machines, Inc., and hardware designed by MassPar, Inc., or other general-purpose parallel computational hardware.

A general-purpose computer system according to one embodiment of the invention is configured to perform information integration. It should be appreciated that the system may perform other functions, including hierarchical analysis, and the invention is not limited to having any particular function or set of functions.

For example, various aspects of the invention may be implemented as specialized software executing in a general-purpose computer system 100 such as that shown in FIG. 8A. The computer system 100 may include a processor 103 connected to one or more memory devices 104, such as a disk drive, memory, or other device for storing data. Memory 104 is typically used for storing programs and data during operation of the computer system 100. Components of computer system 100 may be coupled by an interconnection mechanism 105, which may include one or more busses (e.g., between components that are integrated within a same machine) and/or a network (e.g., between components that reside on separate discrete machines). The interconnection mechanism 105 enables communications (e.g., data, instructions) to be exchanged between system components of system 100. Computer system 100 also includes one or more input devices 102, for example, a keyboard, mouse, trackball, microphone, touch screen, and one or more output devices 101, for example, a printing device, display screen, speaker. In addition, computer system 100 may contain one or more interfaces (not shown) that connect computer system 100 to a communication network (in addition or as an alternative to the interconnection mechanism 105.

The storage system 106, shown in greater detail in FIG. 8B, typically includes a computer readable and writeable nonvolatile recording medium 201 in which signals are stored that define a program to be executed by the processor or information stored on or in the medium 201 to be processed by the program. The medium may, for example, be a disk or flash memory. Typically, in operation, the processor causes data to be read from the nonvolatile recording medium 201 into another memory 202 that allows for faster access to the information by the processor than does the medium 201. This memory 202 is typically a volatile, random access memory such as a dynamic random access memory (DRAM) or static memory (SRAM). It may be located in storage system 106, as shown, or in memory system 104, not shown. The processor 103 generally manipulates the data within the integrated circuit memory 104, 202 and then copies the data to the medium 201 after processing is completed. A variety of mechanisms are known for managing data movement between the medium 201 and the integrated circuit memory element 104, 202, and the invention is not limited thereto. The invention is not limited to a particular memory system 104 or storage system 106.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 100 is shown by way of example as one type of computer system upon which various aspects of the invention may be practiced, it should be appreciated that aspects of the invention are not limited to being implemented on the computer system as shown in FIG. 8A. Various aspects of the invention may be practiced on one or more computers having a different architecture or components that that shown in FIG. 8A.

Computer system 100 may be a general-purpose computer system that is programmable using a high-level computer programming language. Computer system 100 may be also implemented using specially programmed, special purpose hardware. In computer system 100, processor 103 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for integrating multiple pieces of information, the system comprising:
an at least two-dimensional array of locally-connected modules, the modules being configured to have a plurality of attractor states; and
a plurality of information elements, positioned relative to the array, that provide information to the array in the form of activity patterns which travel within the array via local connections between the modules; wherein
for a positioning of the information elements, each module of a first subset of the modules first receives an activity pattern from a first information element coincidentally with first receiving an activity pattern from a second information element; and
each module of the first subset of modules has an attractor state that corresponds to a coincidence of the activity patterns from the first and second information elements.

2. A system as in claim 1, wherein at least one module of the first subset of modules first receives an activity pattern from a third information element coincidentally with first receiving an activity pattern from a fourth information element.

3. A system as in claim 2, wherein the system identifies the at least one module.

4. A system as in claim 1, wherein at least one module of the first subset of modules first receives an activity pattern from a third information element coincidentally with first receiving an activity pattern from a fourth information element, and also receives an activity pattern from a fifth information element coincidentally with first receiving an activity pattern from a sixth information element.

5. A system as in claim 4, wherein the system identifies the at least one module.

6. A system as in claim 1, wherein the first subset of modules is within an interference pattern and a plurality of interference patterns are present within the array of modules.

7. A system as in claim 6, wherein a module of the first subset of modules has an attractor state that corresponds to being within one of the interference patterns.

8. A system as in claim 6, wherein a module of the first subset of modules has an attractor state that corresponds to being within two of the interference patterns.

9. A system as in claim 6, wherein a module of the first subset of modules has an attractor state that corresponds to being within three of the interference patterns.

10. A system as in claim 2, further comprising a hierarchy component that generates a hierarchy of modules based on results of multiple instances of positionings of the plurality of information elements relative to the array; wherein
the results comprise a tracking of which modules of the first subset of modules first receives an activity pattern from a third information element coincidentally with first receiving an activity pattern from a fourth information element for at least two instances of positionings of the plurality of information elements.

11. A system as in claim 1, wherein the information elements are positioned on edges of the array.

12. A system as in claim 1, wherein the information elements are positioned within the array.

13. A system as in claim 1, wherein the array is part of a group of attractor networks.

14. A system as in claim 10, adapted to receive electromagnetic pulse parameter values of a plurality of electromagnetic pulses, wherein the electromagnetic pulse parameter values are assigned to the information elements and the information elements are placed relative to the array based on the values of the electromagnetic pulse parameters.

15. A system as in claim 14, wherein the electromagnetic pulses are classified based on the hierarchy of modules.

16. A system as in claim 14, wherein the electromagnetic pulse parameters comprise frequency and at least two other electromagnetic pulse parameters.

17. A system as in claim 16, wherein the results aid in investigating the presence of emitters of the electromagnetic pulses that are emitted from frequency agility emitters.

18. A system as in claim 13, wherein the hierarchy of modules includes a hierarchy based on the number of times each module of the first subset of modules received an activity pattern from a third information element coincidentally with first receiving an activity pattern from a fourth information element during all of the multiple instances of placements of the plurality of information elements relative to the array.

19. A system as in claim 1, wherein the activity patterns are vector patterns.

20. A system as in claim 1, wherein the modules correspond in their properties to attractor neural networks.

21. A system as in claim 1, wherein the modules comprise CPUs.

22. A system as in claim 1, wherein first receiving an activity pattern from a first information element coincidentally with first receiving an activity pattern from a second information element comprises first receiving an activity pattern from a first information element approximately simultaneously with first receiving an activity pattern from a second information element.

23. A method of integrating data, the method comprising:
(a) spatially representing, relative to an array of array elements, values for at least three parameters by placing each parameter value on a separate span of values;
(b) identifying an array element that is approximately equidistant from each spatially-represented parameter value of a first pair of spatially-represented parameter values and equidistant from each spatially represented parameter value of a second pair of spatially-represented parameter values.

24. A method as in claim 23, wherein the second pair has no spatially-represented parameter values in common with the first pair.

25. A method as in claim 23, wherein the second pair has one spatially-represented parameter value in common with the first pair.

26. A method as in claim 23, wherein (b) comprises:
identifying an interference pattern for each pair of parameter values; and
identifying array elements that include two or more interference patterns.

27. A method as in claim 23, wherein (b) further comprises identifying an array element that is additionally approximately equidistant from each spatially-represented parameter value of a third pair of spatially-represented parameter values.

28. A method as in claim 23, further comprising:
(c) for each array element that is approximately equidistant from two parameter values, determining the number of parameter values from which the array element is approximately equidistant.

29. A method as in claim 28, further comprising:
(d) classifying array elements based at least in part on the number of parameter values from which the array elements are approximately equidistant.

30. A method as in claim 23, further comprising:
repeating (a) and (b) using new values for the three parameters; and
generating a hierarchy of array elements based at least in part on the number of times that an array element is identified during the performances of (b).

31. A method as in claim 23, wherein the at least three parameters comprise electromagnetic pulse parameters.

32. A method as in claim 31, wherein the electromagnetic pulse parameters comprise frequency and at least two other electromagnetic pulse parameters.

33. A method as in claim 31, wherein the electromagnetic pulse parameters comprise frequency, intensity, pulse width, angle of arrival, and time of arrival.

34. A method as in claim 23, wherein the three parameters comprise flow cytometry parameters.

35. A computer-readable medium having computer-readable signals stored thereon that define instructions that, as a result of being executed by a computer, instruct the computer to perform a method of identifying higher-stability coincidences representing relationships between information elements, the method comprising acts of:
(a) positioning a plurality of information elements on a plurality of associated spans of values, the spans being situated relative to an array of array elements, the position of each information element on its associated span being based on a first value contained by the information element;
(b) identifying array elements that include at least two geometrical constructs related to the position of the information elements having first values;
(c) repositioning each of the plurality of information elements on its associated span of values, the position of each information element on its associated span being based on a second value contained by the information element, wherein the second value of at least one of the information elements is different from the first value of the information element;
(d) identifying array elements through that include at least two geometrical constructs related to the position of the information elements having second values; and
(e) differentiating between array elements identified in both (b) and (d) as compared to array elements identified in only one of (b) and (d).

36. A method as in claim 35, further comprising:
repeating (c) and (d) for a plurality of values; and
(e) creating a hierarchy of array elements based on the number of times positioning or repositioning the information elements results in an array element including at least two geometrical constructs related to the position of the information elements.

37. A method as in claim 36, wherein the geometrical constructs are perpendicular bisectors of linear connections between each pair of information elements.

38. A method as in claim 35, wherein the plurality of spans of values comprises a plurality of axes.

39. A method as in claim 38, wherein the axes comprise linear axes situated relative to an array of grid spaces.

40. A method as in claim 39, wherein the array of array elements is two-dimensional array, and the plurality of axes comprises at least four axes.

41. A method as in claim 40, wherein each of the at least four axes is situated perpendicularly to two of the axes.

42. A method as in claim 40, wherein the geometrical constructs are perpendicular bisectors of linear connections between each pair of information elements.

43. A method as in claim 35, wherein at least one of the information elements has a numerical value.

44. A method as in claim 35, wherein at least one of the information elements has a qualitative value.

45. A method as in 35, wherein the plurality of spans of values comprises a plurality of surfaces.

46. A method as in claim 45, wherein the array of array elements is three-dimensional.

47. A method as in claim 35, wherein the array of array elements is at least four-dimensional.
